(19) United States
(12) Patent Application Publication
(10) Pub. No.: US 2007/0035062 A1
(43) Pub. Date: Feb. 15, 2007

(54) Method and facility for the production of a layer-like part

(75) Inventors: Christian Hansen, Berlin (DE); Ursus Kruger, Berlin (DE); Uwe Pyritz, Berlin (DE)

Correspondence Address: YOUNG & THOMPSON, 745 SOUTH 23RD STREET, 2ND FLOOR, ARLINGTON, VA, 22202, US

(73) Assignee: Siemens Aktiengesellschaft, Munchen (DE)

(21) Appl. No.: 10/572,939

(22) PCT Filed: Sep. 28, 2004
(86) PCT No.: PCT/DE04/02203

§ 371 Date: Mar. 22, 2006

(30) Foreign Application Priority Data
Sep. 29, 2003 (DE) 103 46 368.2

(51) Int. Cl. B29C 41/34

(52) U.S. Cl. 264/215; 425/93; 425/269

(57) ABSTRACT

Disclosed is a method for producing an HTSC band on a substrate band, for example, a strong bond being created between the substrate band and the band as a result of the production process (e.g. PVD process or galvanic deposition). According to the invention, separation of the highly adhesive band from the substrate band is aided by the fact that the substrate band is made of a shape memory alloy, the shape memory of the band being activated in a separating device by heating and, possibly, cooling. Tension-related stress is generated in the joint on the boundary surface between the bands as a result of the substrate being deformed such that separation of the band from the substrate band is aided or even caused. Also disclosed is a production facility in which the substrate band is made of a shape memory alloy.

The invention relates to a method for producing a layer-like part in which the part is created on a substrate band by coating of the substrate, the substrate consisting of a shape memory alloy, the substrate coated with the part is subjected to temperature control in such a way that the substrate undergoes a change in shape on account of the shape memory and the part is separated from the substrate band.

U.S. Pat. No. 6,024,907 discloses a method in which a plastic film or sheet is produced by means of a suitable creating device. This film is subsequently applied to an endless belt or band of a shape memory alloy for a surface treatment, this band having a suitable surface texture. The application of the sheet takes place by means of two pressure rollers. To allow the textured sheet subsequently to be better detached from the substrate band, the shape memory of the substrate band is activated by heating or cooling, so that the stresses occurring between the substrate band and the plastic film on account of the change in shape of said substrate band facilitate the detachment of the plastic film.

A similar method is known from U.S. Pat. No. 4,530,739. In the method according to this document, a layer-like part in the form of an endless sheet is produced on a rotating roller serving as a substrate. For this purpose, the rotating roller is immersed in an electroplating bath, from which the part to be produced is deposited onto the roller. As soon as the layer-like part has reached the desired thickness, it is pulled off from the roller and wound up, for example on a supply roller.

The detachment process of the layer-like part from the substrate roller is assisted by heating or cooling of the layer-like part and the substrate roller. This is so because, on account of the different coefficients of thermal expansion of the substrate roller and the layer-like part created, a mechanical stress (hereinafter also referred to as stress) is produced as a result of distortion-induced lattice stresses in the microstructure of the substrate roller and of the layer-like part along their common boundary surface, which stresses weaken the bonds of the atoms in the boundary surface and so facilitate, or even bring about, separation of the layer-like part from the substrate roller by pulling-off. The effectiveness of the assisting effect of heating or cooling on the separating process depends primarily on the difference between the coefficients of thermal expansion of the substrate roller and of the layer-like part.

The object of the invention is to provide a method for producing a layer-like part on a substrate in which assistance for the separation of the layer-like part from the substrate by means of a shape memory effect can be used particularly advantageously.

This object is achieved according to the invention by the microstructure texture of the substrate band being transferred to the layer-like part by the latter undergoing quasi-epitaxial growth. The change in shape of the substrate on account of its shape memory is subsequently used to produce a stress along the common boundary surface between the substrate and the part, facilitating the separation of the substrate and the part, after the coating of the substrate. The shape memory effect can be brought about for example by a substrate band on which the part has been created contracting along its longitudinal extent, the lattice distortions along the boundary surface produced as a result of the adhesion between the substrate and the part bringing about the stress. The stress then advantageously leads to a reduction in the forces required for pulling the part off the substrate or even already leads to its separation, so that pulling-off can be performed substantially free from forces.

The method can then be used according to the invention for the quasi-epitaxial growth of layer-like parts on a substrate and their subsequent detachment. In the quasi-epitaxial growth, a texture of the substrate microstructure is transferred to the growing, layer-like part, so that the latter has the same microstructure texture. The quasi-epitaxial growth may take place for example by means of PVD processes or by galvanic deposition. In this way it is advantageously possible for example for high-temperature superconductors (HTSCs) such as YBa₂Cu₃O₇ (YBCO) or else substrates suitable for the deposition of such HTSCs to be produced with a textured microstructure finish at low cost. A method for the quasi-epitaxial growth of HTSC layers is described for example in DE 101 36 890 A1.

The method according to the invention can be used particularly advantageously for the separation of quasi-epitaxially layer-like parts from the substrate, in which method the separation is facilitated by the stress produced at the boundary surface between the substrate and the part.

This is so because, on account of the production process, in which the microstructure texture is transferred from the substrate to the layer-like part, the adhesion between the substrate and the part created is particularly great, since the microstructure of the part and substrate fit together as it were like a key in a lock. Therefore, a reduction of the adhesion between the two components involved in the separation by building up a stress in the microstructure is a necessary precondition for it to be possible in the first place for thin layer-like parts in particular to be pulled off from the substrate. Furthermore, after the separation process, the surface of the layer-like part forming the boundary surface with respect to the substrate, on the one hand, and the substrate surface, on the other hand, are intended to reproduce the microstructure texture as free from defects as possible, in order that for example the substrate can be used repeatedly for quasi-epitaxial growth, or the layer-like part itself can likewise be used as a substrate for a further production step of quasi-epitaxial growth. This at least substantial freedom from defects of the surface can be achieved if the separation is assisted by formation of a stress by the method according to the invention.

According to a first refinement of the invention, it is provided that, in the case of the substrate, the one-way effect can be used by the substrate being deformed before coating and heated after coating in such a way that the substrate goes over into its undeformed shape. In the case of the one-way effect of shape memory alloys, use is made of the fact that they can be pseudoplastically deformed in a specific temperature range, i.e. this pseudoplastic deformation is reversed when they leave this temperature range as a result of heating, and the part made of the shape memory alloy reverts to its originally undeformed shape. If a substrate band for example is used in the method, it can advantageously be stretched by simple means, subsequently coated and the coating detached from the substrate band by using the one-way effect, that is a contraction of the band. In this way it is advantageously possible to create substrates, in particular substrate bands, with properties which can be predicted well with regard to the shape memory effect and which also can withstand a comparatively high number of production cycles of creating the sheet on the substrate band. According to a second refinement of the invention, it is provided that, in the case of the substrate, the two-way effect is used by the substrate being subjected to temperature control before coating in such a way that it goes over into its one shape and the substrate being subjected to temperature control after coating in such a way that it goes over into its other shape. The two-way effect of shape memory alloys can only be used if the part with the shape memory effect is first subjected to a special treatment, known as training. In this case, the most common methods create deliberately irreversible deformations in the part, which lead to the formation of stress-inducing microstructural defects in the microstructure of the shape memory alloy. After going through a number of training cycles, these microstructural stresses form anisotropically in the microstructure and bring about the two-way effect by the anisotropy. When the part comprising the shape memory alloy is heated, it is transformed by the already described one-way effect into the shape with the irreversible deformation element created by the training. If the part is cooled, the part reverts to the trained deformation state on account of the characteristic stress distribution in the part created by the training.

By alternate heating and cooling of the part, this process can be repeated.

The two-way effect is advantageous for the method for producing the layer-like part, in order to assist detachment on the basis of the shape memory effect alone by suitable temperature control of the process (i.e. heating and cooling to the necessary temperature ranges). In this case, it is particularly advantageous if the substrate is alternately heated and cooled after coating in such a way that it alternately goes over into its one shape and its other shape. The repeated change in shape of the substrate allows a detachment process between the substrate and the part to take place in a number of steps, i.e. complete detachment, or at least detachment adequate for pulling-off, does not already take place with the first shape-memory-induced change in shape of the substrate.

The invention also relates to a production facility with a substrate band for producing a layer-like part in sheet form, the substrate band being led through a creating device for the part and a temperature-controllable separating device to obtain the part, and the substrate band consisting of a shape memory alloy. Such a separating device is described in U.S. Pat. No. 6,024,907, already mentioned at the beginning. The way in which the separating device operates was already explained in detail at the beginning.

The object of the invention is to provide a separating device for a part located on a substrate, with which assistance for the separation of the layer-like part from the substrate by means of a shape memory effect can be used particularly advantageously.

This object is achieved according to the invention by the creating device being intended for quasi-epitaxial growth of the layer-like part onto the substrate; in particular comprising a facility for PVD coating of for galvanic depositing. This allows the temperature-controlled separating device to be used to assist the separation between the substrate band and the layer-like part by using the shape memory effect. In this way, the part created can be advantageously detached particularly gently from the substrate band. The fact that the shape memory effect of the substrate band can be used for separation of parts that have grown quasi-epitaxially onto the substrate and the resultant advantages have already been explained in detail in connection with the method according to the invention.

It goes without saying that separation of the substrate and the layer-like part can be additionally facilitated by further effects. For example, given different coefficients of thermal expansion, cooling or heating of the substrate and the part, as described in U.S. Pat. No. 4,530,739 already mentioned at the beginning, leads to the formation of an additional stress, which can be superposed in an intensifying manner on the stress based on the shape memory. According to another possibility, on the precondition that at least one of the components involved (substrate band or part) is ferromagnetic, the effect of magnetostriction can be used. For this purpose, the substrate provided with the layer-like part is exposed to a magnetic field, which leads to a change in shape of the other, ferromagnetic component on account of the effect of magnetostriction. With a suitable alignment of the magnetic field, this brings about the formation of an additional stress in the boundary surface between the substrate and the part.

According to a refinement of the invention, it is provided that the creating device is preceded by a deforming device, in particular a stretching device, for the substrate band. With the deforming device, the one-way effect can be advantageously used for the substrate, for example by the latter being stretched by means of the deforming device, subsequently coated with the layer-like part in the creating device and this part being pulled off from the substrate, using the one-way effect on the basis of heating of the substrate. All the steps that are essential for the method according to the invention can be advantageously brought together in the production facility. Another refinement of the invention provides that the creating device is preceded by a temperature-controlling device for the substrate band. The temperature-controlling device may be advantageously used for using a two-way effect with which “the substrate is trained”.

A final refinement of the method provides that the substrate band is configured as an endless belt circulating in the production facility. This allows the process to be advantageously carried out particularly efficiently, for which reason the production facility is suitable for large-scale applications.

Further details of the invention are described below on the basis of the drawing, in which:

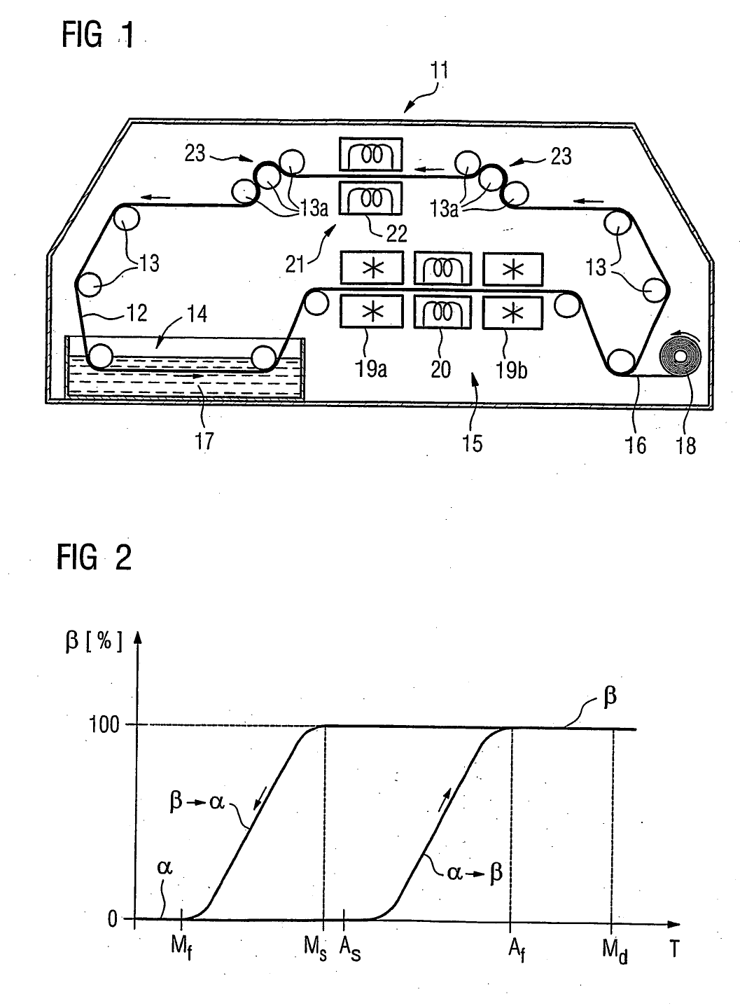

FIG. 1 schematically shows a production facility for producing a layer-like part and its subsequent detachment from a circulating substrate band,

FIG. 2 schematically shows the microstructural transformation α→β→α, which induces the shape memory effect, in dependence on the temperature T.

In FIG. 1 there is shown a production facility 11, in which is substrate band 12 is guided and driven by transporting rollers 13. The substrate band 12 is configured as an endless belt and circulates in the production facility in a way corresponding to the arrows indicated. The production facility has a production device 14 and a separating device 15 for a layer-like part in the form of a band 16, the substrate band 12 defining a transporting path through the production facility 11, which runs through the production facility 14 and the separating device 15.

The production device 14 is formed by an electroplating bath 17, in which the sheet 16 grows quasi-epitaxially, i.e. the microstructural texture of the substrate band is transferred to the sheet 16 produced in the electroplating bath by coating of the substrate band 12. Subsequently, the substrate band 12 coated with the sheet 16 is passed through the separating device 15, in which the adhesion between the substrate band 12 and the sheet 16 produced is reduced or even completely eliminated, so that the sheet 16 can be pulled off from the substrate band 12 and wound up onto a supply roller 18. After the pulling-off of the sheet 16, the substrate band 12 is returned as an endless loop into the electroplating bath 17.

In the separating device 15, the sheet 16 runs successively through a cooler 19a, a heater 20 and a further cooler 19b. By suitable cooling and heating in the separating device, the separation of the substrate band is induced. During the return of the substrate band 12 from the separating device 15 to the electroplating bath 17, it also runs through a conditioning device 21, which serves for the suitable preparation of the substrate band for coating, so that, after the coating in the separating device, the shape memory effect can be used to assist or bring about the separation. The conditioning device has on the one hand a heater 22, and on the other hand a stretching device 23, which comprises special transporting rollers 13a which respectively roll on one another. The substrate band is passed between the transporting rollers 13a rolling on one another, so that the applied pressure of respectively adjacent transporting rollers 13a prevents the substrate band 12 from slipping on them. Stretching of the band is achieved by the transporting rollers 13a downstream of the heater 22 rolling at higher speed than the transporting rollers 13a upstream of the heater.

Depending on the shape memory effect used, the separating device 14 and the conditioning device 21 are described in different, coordinated functional states. If the one-way effect is used, heating by the heater 22 is not necessary, but instead the stretching device 23 is used, in order to create a deformation of the substrate band 12. Consequently, after running through the electroplating bath 17, it merely has to be ensured by heating by means of the heater 20 in the separating device that the substrate band goes over into the unstretched form by using the shape memory.

If the two-way effect is used, the stretching device 23 is deactivated by synchronizing the rotational speeds of all the transporting rollers 13a. Instead, heating is performed by the heater 22, which initiates the shape memory effect in the substrate band in one direction. After running through the electroplating bath 17, the shape memory effect can be activated at least once in the other direction by using at least the cooler 19a. By using the heater 20 and the cooler 19b, the cycle of the two-way effect is run through a second time, whereby a greater reduction in the bonding forces between the substrate band 12 and the sheet 16 is achieved. A further possibility for using the two-way effect is to exchange the coolers 19a, 19b and the heaters 20, 22 for one another, whereby the two-way effect in the substrate band is used in a way that is precisely complementary to the sequence described above.

In FIG. 2 there is shown the phase transformation that takes place in shape memory alloys such as NiTi for example and brings about the shape memory effect. The shape memory effect occurs in alloys in which a thermoplastic martensitic phase transformation is possible. The parts provided with the shape memory must have a single-phase microstructure. In the low-temperature phase, the microstructure is in the form of martensite α. If the microstructure is heated, an austenitic microstructure β gradually forms above an austenite start temperature Aₛ, the β phase being formed 100% above the temperature A_{f} (austenite finish). If the austenite is then cooled, it transforms again into martensite α within the range from Mₛ, to M_{f} (martensite start to martensite finish), a hysteresis being passed through in the process described. In a temperature range between A_{f} and M_{d}, the part shows a pseudoelastic behavior. This means that stress-induced martensite can form in the austenitic microstructure, reverting again when the stresses subside.

Below the temperature M_{f}, the part behaves pseudoplastically, i.e. it may initially remain permanently deformed, but heating of the part above A_{f} activates the shape memory effect in the part, so that it deforms back by using the one-way effect.

The two-way effect is “trained” by training with plastic deformation of the part below M_{f} with irreversible elements. For using the two-way effect, the part is alternately heated and cooled below M_{f} and above A_{f} and thereby reversibly changes between two shapes.

1. A method for producing a layer-like part (16) in which
the part (16) is created on a substrate (12) by coating of the substrate (12), the substrate (12) consisting of a shape memory alloy,
the substrate (12) coated with the part (16) is subjected to temperature control in such a way that the substrate undergoes a change in shape on account of the shape memory effect
and the part (16) is separated from the substrate band (12),
characterized in that the microstructure texture of the substrate band is transferred to the layer-like part by the latter undergoing quasi-epitaxial growth.

2. The method as claimed in claim 1, characterized in that, in the case of the substrate (12), the one-way effect is used by the substrate being deformed before coating and heated after coating in such a way that the substrate goes over into its undeformed shape.

3. The method as claimed in claim 1, characterized in that, in the case of the substrate (12), the two-way effect is used by the substrate being subjected to temperature control before coating in such a way that it goes over into its one shape and the substrate being subjected to temperature control after coating in such a way that it goes over into its other shape.

4. The method as claimed in claim 3, characterized in that the substrate (12) is alternately heated and cooled after coating in such a way that it alternately goes over into its one shape and its other shape.

5. A production facility with a substrate band (12) for producing a layer-like part (16) in sheet form, the substrate band (12) being led through a creating device (17) for the part and a temperature-controllable separating device (15) to obtain the part, and the substrate band consisting of a shape memory alloy, characterized in that the creating device is intended for quasi-epitaxial growth of the layer-like part onto the substrate band.

6. The production facility as claimed in claim 5, characterized in that the creating device is a facility for PVD coating or for galvanic coating.

7. The production facility as claimed in claim 5, characterized in that the creating device (17) is preceded by a deforming device, in particular a stretching device (23), for the substrate band.

8. The production facility as claimed in claim 5, characterized in that the creating device (17) is preceded by a temperature-controlling device (22) for the substrate band.

9. The production facility as claimed in claim 5, characterized in that the substrate band (12) is configured as an endless belt circulating in the production facility.

10. The production facility as claimed in claim 6, characterized in that the creating device (17) is preceded by a deforming device, in particular a stretching device (23), for the substrate band.

11. The production facility as claimed in claim 6, characterized in that the creating device (17) is preceded by a temperature-controlling device (22) for the substrate band.

12. The production facility as claimed in claim 6, characterized in that the substrate band (12) is configured as an endless belt circulating in the production facility.

13. The production facility as claimed in claim 7, characterized in that the substrate band (12) is configured as an endless belt circulating in the production facility.

14. The production facility as claimed in claim 8, characterized in that the substrate band (12) is configured as an endless belt circulating in the production facility.
